(19) United States
(12) Patent Application Publication
(10) Pub. No.: US 2008/0006428 A1
(43) Pub. Date: Jan. 10, 2008

(54) Side-by-side outlet

(76) Inventor: Randy E. Bryan, Altoona, PA (US)

Correspondence Address: SUNG I. OH, PROFESSIONAL LAW CORPORATION, 710 QUAIL VALLEY LANE, WEST COVINA, CA, 91791, US

(21) Appl. No.: 11/482,001

(22) Filed: Jul. 6, 2006

(51) Int. Cl. H02G 3/08

(52) U.S. Cl. 174/50

(57) ABSTRACT

An outlet box includes two electrical boxes in side by side relationship with each other and which are connected together so the open ends of the boxes face away from each other. This orientation allows the boxes to be used in adjoining rooms of a building and both secured to the same stud.

### TECHNICAL FIELD OF THE INVENTION

The present invention relates to the general art of electrical devices, and to the particular field of outlet boxes.

### BACKGROUND OF THE INVENTION

Conventional wall mounted electrical outlets include a box, whether of metal or plastic, for receiving three conductor electrical cables. The terminal end of each conductor is mechanically fastened to corresponding electrical contacts of a conventional socket assembly. One or more apertures in the box are present to permit ingress of a cable and egress of another cable. In the event of the latter, the ends of each conductor of such cable must be attached to the corresponding electrical connections of the outlet socket assembly. Alternatively, corresponding conductors of each cable must be electrically and mechanically secured to one another with a device known as a wire nut. A pig-tail conductor is secured by each wire nut to each conductor to provide electrical power to the corresponding electrical contact of the socket assembly. When two sockets of each socket assembly are present, as is conventional, further pig-tails must be used to connect the sockets in parallel.

The amount of time and effort to cut and then insert the end of each cable into the electrical box is time consuming. Additional time and numerous separate operations must be carried out to effect the appropriate electrical connections. Each cable must be routed through the studs of a wall from one location of an electrical box to another. This requires drilling holes in each intervening stud and threading the cable therethrough. Such work is time consuming and laborious.

Conventional electrical outlet boxes are secured to a wall stud by nails or the like. A cutout is provided in the wall board of the wall through which the electrical outlet box extends to position the socket assembly essentially flush with the exterior surface of the wall board. An aperture cover plate, penetrably receiving the terminal end of each socket of the socket assembly, is affixed to the electrical outlet box by screws. Often, due to sloppy workmanship or inattention, the electrical outlet box is not in proper alignment with the wall board. This results in a skewed attachment of the cover plate since no provision for aligning the cover plate with the wall board is provided. The result is aesthetically displeasing.

Generally, the major expense attendant wiring a house, or any building, is the cost of the labor involved as the parts, including the cables, are inexpensive relative to the total cost. By reducing the labor costs of skilled electricians through a reduction in time spent, significant savings may be affected.

### SUMMARY OF THE INVENTION

The above-discussed disadvantages of the prior art are overcome by an outlet box that includes two electrical boxes in side by side relationship with each other and which are connected together so the open ends of the boxes face away from each other. This orientation allows the boxes to be used in adjoining rooms of a building and both secured to the same stud.

Using the side-by-side electrical box embodying the present invention will permit an electrician to install receptacle outlets, light switches, cable connections, and phone jacks in adjoining rooms using only one framing stud and thus will eliminate the need to “block out” a studded wall near the doorway in order to install the necessary apparatus on both sides. The side-by-side outlet embodying the present invention also permits inclusive installation of high and low voltage wiring.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a front elevational view of a side-by-side outlet embodying the present invention.

FIG. 2 is a rear elevational view of a side-by-side outlet embodying the present invention.

FIG. 3 is a top plan view of the side-by-side outlet embodying the present invention.

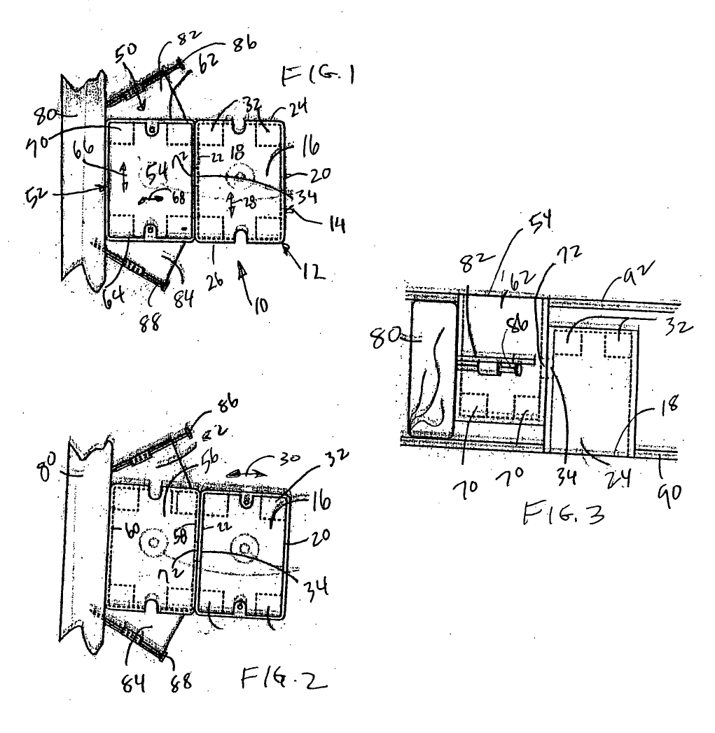

### DETAILED DESCRIPTION OF THE INVENTION

Referring to the figures, it can be understood that the present invention is embodied in a side-by-side outlet 10. Outlet 10 comprises a first-outlet box 12 which includes a housing 14. Housing 14 has a back wall 16, an open front 18, a first side wall 20, a second side wall 22, a first end wall 24 which is a top wall when the first outlet box is in use, a second end wall 26 which is a bottom wall when the first outlet box is in use, and a height dimension 28 which extends between the first end wall of housing 14 and the second end wall of housing 14 of the first outlet box. A width dimension 30 extends between first side wall 20 and second side wall 22.

A plurality of knockouts, such as knockouts 32, are defined through the back wall of the housing of the first outlet box and are used to accommodate cables, cords and the like. At least one knockout 34 is defined through second side wall 22 of the housing of the first outlet box.

A second outlet box 50 includes a housing 52 which has a back wall 54, an open front 56, a first side wall 58, a second side wall 60, a first end wall 62 which is a top wall when second outlet box 50 is in use, a second end wall 64 which is a bottom wall when the second outlet box is in use, and a height dimension 66 which extends between first end wall 62 and second end wall 66. A width dimension 68 extends between first side wall 58 and second side wall 60.

A plurality of knockouts, such as knockout 70, are defined through the back wall of the housing of the second outlet box to accommodate cables, cords and the like in the manner of outlet boxes. At least one knockout 72 is defined through first side wall 58 of the second outlet box.

First side wall 58 of second outlet box 50 is fixed to second side wall 22 of first outlet box 12 with open fronts 18 and 56 of both outlet boxes facing in opposite directions and knockout element 34 in second side wall 22 of first outlet box 12 being aligned with knockout element 72 defined through first side wall 58 of second outlet box 50. Second side wall 60 of second outlet box 50 is fixed to a support element 80, such as a stud or the like, to mount unit 10.

A first flange 82 is attached to first end wall 62 of the second outlet box and a second flange 84 is attached to second end wall 64 of the second outlet box. A first fastening element 86 is used to fix first flange 82 to the support element and a second fastening element 88 is used to fix second flange 84 to support element 80.

As can be understood from FIG. 2, the outlet boxes are mounted on a support to have the open fronts 18 and 54 located in walls, such as walls 90 and 92 respectively. Unit 10 is mounted where there is a need for a switch or an electrical connection on both sides of a wall, such as at a door or the like. Cables, etc are then run to both outlet boxes as needed.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A side-by-side outlet consisting of:
A) a first outlet box which includes
(1) a housing having
(a) a back wall,
(b) an open front,
(c) a first side wall,
(d) a second side wall,
(e) a first end wall which is a top wall when the first outlet box is in use,
(f) a second end wall which is a bottom wall when the first outlet box is in use,
(g) a height dimension which extends between the first end wall of the housing of the first outlet box and the second end wall of the housing of the first outlet box,
(h) a width dimension which extends between the first side wall of the housing of the first outlet box and the second side wall of the housing of the first outlet box,
(i) a plurality of knockouts defined through the back wall of the housing of the first outlet box,
(j) at least one knockout defined through the second side wall of the housing of the first outlet box;
B) a second outlet box which includes
(1) a housing having
(a) a back wall,
(b) an open front,
(c) a first side wall,
(d) a second side wall,
(e) a first end wall which is a top wall when the second outlet box is in use,
(f) a second end wall which is a bottom wall when the second outlet box is in use,
(g) a height dimension which extends between the first end wall of the housing of the second outlet box and the second end wall of the housing of the second outlet box,
(h) a width dimension which extends between the first side wall of the housing of the second outlet box and the second side wall of the housing of the second outlet box,
(i) a plurality of knockouts defined through the back wall of the housing of the second outlet box,
(j) at least one knockout defined through the first side wall of the housing of the second outlet box;
C) the first side wall of the second outlet box being fixed to the second side wall of the first outlet box with the open fronts of both outlet boxes facing in opposite directions and the knockout element in the second side wall of the housing of the first outlet box being aligned with the knockout element defined through the first side wall of the housing of the second outlet box;
D) the second side wall of the second outlet box being fixed to a support element;
E) a first flange attached to the first end wall of the second outlet box;
F) a second flange attached to the second end wall of the second outlet box;
G) a first fastening element fixing the first flange to the support element; and
H) a second fastening element fixing the second flange to the support element.

2. (canceled)

3. A side-by-side outlet consisting of:
A) two outlet boxes which are attached together, each outlet box including an open front, with the open fronts of the two outlet boxes facing in opposite directions;
B) each outlet box having a knockout opening defined therein, with the knockout openings of the outlet boxes being aligned with each other; and
C) a mounting unit on one of the outlet boxes which mounts the two outlet boxes on a support element.
